(19) United States
(12) Patent Application Publication
(10) Pub. No.: US 2026/0271900 A1
(43) Pub. Date: Sep. 17, 2026

(54) INTELLIGENT FISHING REEL CONTROL SYSTEM AND METHOD

(71) Applicant: Piscisea Tech Inc., Austin, TX (US)

(72) Inventors: Saier Wu, Shenzhen (CN); Shengxu Cai, Shenzhen (CN); Chaoning Huang, Dongxing City (CN); Bingyao Tang, Hepu County (CN)

(21) Appl. No.: 19/230,666

(22) Filed: Jun. 6, 2025

(30) Foreign Application Priority Data
Mar. 11, 2025 (CN) 202510281188.X

(51) Int. Cl. A01K 89/017; A01K 97/12; G06F 3/01

(52) U.S. Cl. CPC A01K 89/017; A01K 97/125; G06F 3/011

(57) ABSTRACT

Disclosed are an intelligent fishing reel control system and method, including a host, a sensing module, a motor, a switch module, and a rod-jerking recognition module, where the host is connected to the sensing module, the motor, the switch module, and the rod-jerking recognition module to manage each module. The switch module is configured to activate and switch fishing modes, regulate the motor to operate in different manners in different fishing modes, and supply power to the fishing reel body for line retrieval, line release, and trolling. The sensing module detects hand-applied pressure and regulates the motor to operate at variable rotational speeds or torques. The rod-jerking recognition module is configured to identify a rod-lifting posture and amplitude of a fishing rod, and the module controls the motor to output a first torque for line retrieval, line release, and trolling of the electric fishing reel to attract fish.

### CROSSREFERENCETORELATEDAPPLICATIONS

The present disclosure claims the priority of Chinese Patent Application No. 202510281188.X filed on March 11, 2025, the content of which is incorporated herein by reference in its entirety.

### TECHNICALFIELD

The present disclosure relates to the technical field of intelligent fishing reels, and in particular to an intelligent fishing reel control system and method.

### BACKGROUND

With the advancements in technology, fishing devices have been progressively intelligentized. Electric fishing reels, as novel fishing reels that are motor-driven to achieve automatic line retrieval, demonstrate immense potential in enhancing fishing efficiency and experience.

However, electric fishing reels currently available on the market typically only have automatic line retrieval functions. Although being capable to reduce manual efforts of users to some extent, such fishing reels, due to lack of intelligent control means, users’ increasing needs, and diversity in fishing environments, cannot meet users’ diverse demands for fishing, thereby compromising fishing experience.

### SUMMARY

In order to solve the problems of the prior art that electric fishing reels compromise fishing experience due to failure to meet users’ diverse demands for fishing, the present disclosure provides an intelligent fishing reel control system and method.

In order to achieve the above objective, the present disclosure adopts a technical solution as follows:

An intelligent fishing reel control system is provided to control operations of an electric fishing reel, the electric fishing reel includes a fishing reel body, a fishing rod, and a battery, and the intelligent fishing reel control system includes a host, a sensing module, a motor, a switch module, and a rod-jerking recognition module, where the host is connected to the sensing module, the motor, the switch module, and the rod-jerking recognition module to manage each module;

the switch module is configured to activate and switch fishing modes, regulate the motor to operate in different manners in different fishing modes, and supply power to the fishing reel body for line retrieval, line release, and trolling;

the sensing module is configured to detect hand-applied pressure and regulate the motor to operate at variable rotational speeds or torques according to the detected pressure; and

the rod-jerking recognition module is configured to identify a rod-lifting posture and amplitude of a fishing rod, and when a fish-attracting state is identified, the module controls the motor to output a first torque for line retrieval, line release, and trolling of the electric fishing reel to attract fish.

Preferably, the switch module includes a first switch and a second switch, both the first switch and the second switch are two-stage switches, the first switch is arranged on a grip knob, and the second switch is arranged on the host; and the grip knob is located at a handgrip position of an end portion of a rocker arm handle.

Preferably, the fishing modes include:

a manual mode, activated by a first stage of the first switch of the switch module, where when the user rotates the rocker arm handle, the sensing module drives the motor to output the first torque for accelerating line retrieval of the fishing reel body;

a follow-up mode, activated by a second stage of the first switch of the switch module, where when the user rotates the rocker arm handle, the sensing module drives the motor to output the second torque for accelerating line retrieval of the fishing reel body;

a motion-sensing cranking mode 1, activated by the first stage of the second switch of the switch module, where when the rod-jerking recognition module determines the fish-attracting state according to an identified rod-lifting posture and amplitude of the fishing rod, the motor outputs the first torque for line retrieval, line release, and trolling for attracting fish; and

a motion-sensing cranking mode 2, activated by the second stage of the second switch of the switch module, where the sensing module drives the motor to output the second torque for accelerating line retrieval of the fishing reel body.

Preferably, the system further includes a photographing module connected to the host, and the photographing module is configured for the user to control the action camera to start or stop recording through a shutter button.

Preferably, the system further includes a line length reset module, the line length reset module includes a line length reset button, and the button is configured for automatically resetting the line length after the intelligent fishing reel control system is activated and the motor is started.

Preferably, the switch module further includes a power button, and the power button is connected to the host and configured for activating or deactivating the intelligent fishing reel control system.

An intelligent fishing reel control method, applied to the above intelligent fishing reel control system, includes the following steps:

S1, pressing and holding the power button for a preset duration to power on the fishing reel body for use;

S2, pressing the line length reset button to automatically reset the line length after the motor is started; and

S3, operating the first switch or the second switch to enter a fishing mode.

In the S3, when the user needs to start the motor for assistance in the manual mode, rotational speeds of the motor are adjusted based on the hand-applied pressure detected by the sensing module when the motor outputs the first torque to assist line retrieval of the fishing reel body;

when the user rotates the rocker arm handle in the follow-up mode, the motor outputs the first torque to assist line retrieval, and when the sensing module detects the hand-applied pressure, the motor outputs the second torque to further assist line retrieval of the fishing reel body;

when the user holds the fishing rod with one hand in the motion-sensing cranking mode 1, and when the rod-jerking recognition module determines the fish-attracting state according to an identified rod-lifting posture and amplitude of the fishing rod, the motor outputs the first torque for line retrieval, line release, and trolling for attracting fish;

when the user grips the fishing rod with both hands in the motion-sensing cranking mode 2, the motor outputs the second torque for accelerating line retrieval of the fishing reel body according to the hand-applied pressure detected by the sensing module.

Accordingly, the second torque output by the motor is proportional to the hand-applied pressure, and when the motor outputs the first torque, the rotational speed of the motor is also proportional to the hand-applied pressure.

Preferably, before use, the user needs to install the battery and the fishing reel body onto the fishing rod and insert an interface of the battery to a power port of the fishing reel, and the power button is short-pressed to check a level of the battery.

Preferably, in the fishing mode, a gear ratio of the fishing reel is adjusted through a three- gear mechanical switch, and when the user clearly hears a mechanical clicking sound, it is determined that gear switching is completed.

Compared with the prior art, the present disclosure has the following advantages:

In the present disclosure, the sensing module, the motor, the switch module, and the rod- jerking recognition module are arranged, which enables the user to freely switch between multiple modes such as the manual mode, the follow-up mode, the motion-sensing cranking mode 1, and the motion-sensing cranking mode 2 according to fishing habits, fish species, water environments and other factors. In each mode, targeted handling is allowed, which meets diverse needs for fishing and significantly enhances the user’s fishing experience and fun. Additionally, the rod- jerking recognition module is configured to identify the rod-lifting posture and amplitude of the fishing rod, and when a fish-attracting state is identified, the motor outputs a specific first torque for line retrieval, line release, and trolling to attract fish, which improves the fish attraction and success rates compared to traditional single-mode fishing reels. The sensing module accurately detects hand-applied pressure and regulates the motor to operate at variable rotational speeds or torques according to the detected pressure in real time. During line retrieval, the increased hand- applied pressure proportionally elevates the motor’s rotational speed or output torque. The present disclosure achieves precise control over line retrieval speed and force, saves physical effort of the user, and quickly responds to fish resistance.

### BRIEFDESCRIPTIONOFTHEDRAWINGS

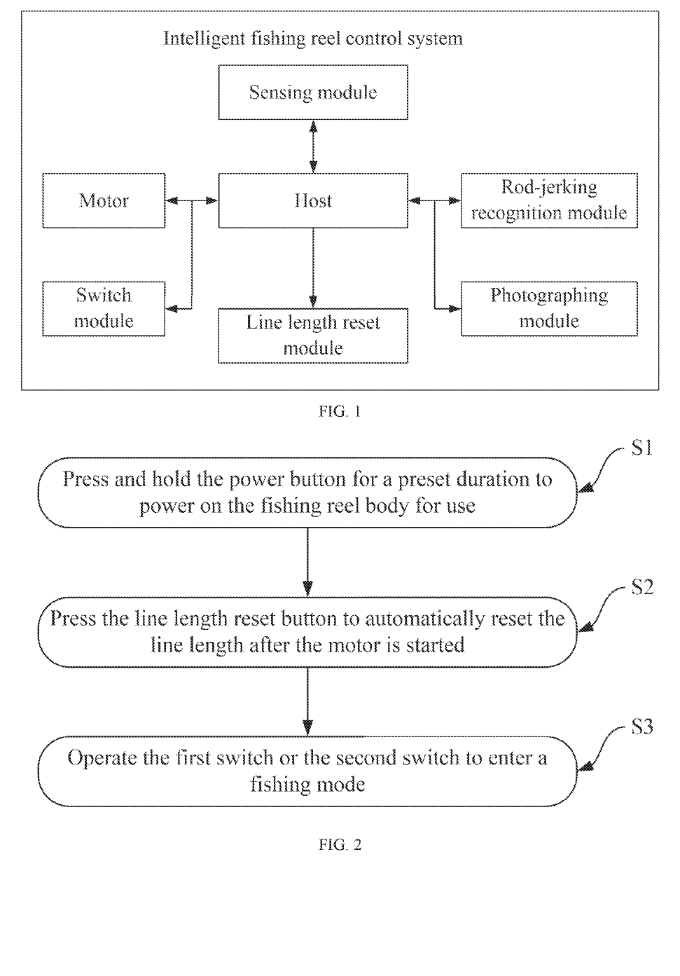

FIG. 1 is a schematic structural diagram of an intelligent fishing reel control system provided by the present disclosure.

FIG. 2 is a flowchart of an intelligent fishing reel control method provided by the present disclosure.

### DETAILEDDESCRIPTIONSOFTHEEMBODIMENTS

The technical solutions in the examples of the present disclosure will be clearly and completely described below in combination with the accompanying drawings in the examples of the present disclosure. Apparently, the examples described are merely some rather than all of the examples of the present disclosure.

In the description of the present disclosure, it is to be understood that the terms “upper”, “lower”, “front”, “rear”, “left”, “right”, "top", "bottom", "inner", "outer", etc. indicate azimuthal or positional relations on the basis of those shown in the drawings only for ease of description of the present disclosure and for simplicity of description, and are not intended to indicate or imply that the referenced device or element must have a particular orientation and be constructed and operative in a particular orientation, and thus may not be construed as a limitation on the present disclosure.

With reference to FIG. 1, an intelligent fishing reel control system is provided to control operations of an electric fishing reel, the electric fishing reel includes a fishing reel body, a fishing rod, and a battery, and the intelligent fishing reel control system includes a host, a sensing module, a motor, a switch module, and a rod-jerking recognition module, where the host is connected to the sensing module, the motor, the switch module, and the rod-jerking recognition module to manage each module. The host serves as a central processing unit of the entire system, and a microcontroller such as an STM32 single-chip microcomputer is operated to achieve command transmission and data exchange with each module. For instance, the host is capable of quickly processing hand-applied pressure data received from the sensing module. The switch module is configured to achieve activation and deactivation of the intelligent fishing reel control system and switch fishing modes. The motor is configured to output variable power according to control instructions from the host, and cooperates with a gearbox to achieve different torques and rotational speeds.

The switch module is configured to activate and switch fishing modes, regulate the motor to operate in different manners (i.e., the motor outputs different torques and rotational speeds) in different fishing modes, and supply power to the fishing reel body for line retrieval, line release, and trolling; the switch module includes a first switch and a second switch, both the first switch and the second switch are two-stage switches, the first switch is arranged on a grip knob, and the second switch is arranged on the host; and the grip knob is located at a handgrip position of an end portion of a rocker arm handle. The grip knob is ergonomically designed to accord with natural hand-grip postures, such that the user easily operates the first switch with the thumb when rotating the rocker arm handle. A first stage of the first switch controls activation of a manual mode, and a second stage thereof controls activation of a follow-up mode. The second switch is arranged on a surface of the host at a prominent position that facilitates operation, a first stage thereof controls activation of a motion-sensing cranking mode 1 (a single-hand mode), and a second stage thereof controls activation of a motion-sensing cranking mode 2 (a double-hand mode).

The sensing module is configured to detect hand-applied pressure and regulate the motor to operate at variable rotational speeds or torques according to the detected pressure; and the sensing module, via a pressure sensor, achieves real-time detection of the pressure applied by the hand to the grip knob or a rocker arm portion of the fishing reel body.

The rod-jerking recognition module is configured to identify a rod-lifting posture and amplitude of a fishing rod, and when a fish-attracting state is identified, the module controls the motor to output a first torque for line retrieval, line release, and trolling of the electric fishing reel to attract fish. The rod-jerking recognition module includes an acceleration sensor, a gyroscope

sensor, and a miniature camera. Both the acceleration sensor and the gyroscope sensor are capable of monitoring motion parameters such as an acceleration and angular velocity of the fishing rod in real time, and the miniature camera captures motion images of the fishing rod and recognizes a posture and amplitude of the fishing rod through an image analysis algorithm. When a fish- attracting state is determined (for instance, when the fishing rod continuously shakes with a small rod-lifting amplitude, it is identified as an oscillatory fish-attracting behavior), the rod-jerking recognition module quickly sends a signal to the host, and the host controls the motor to output a first torque, so as to achieve precise line retrieval, line release, and trolling for attracting fish continuously.

Specifically, the fishing modes include:

The manual mode is activated by the first stage of the first switch of the switch module, when the user rotates the rocker arm handle, the sensing module drives the motor to output the first torque for accelerating line retrieval of the fishing reel body; and when the manual mode is activated and the user rotates the rocker arm handle, the sensing module monitors hand-applied pressure in real time. When the user needs to start the motor for assistance, the host adjusts a duty ratio of a PWM signal output by the motor according to a pressure feedback from the sensing module, the motor outputs the first torque, and the rotational speed thereof is proportional to the hand-applied pressure, which achieves accelerated line retrieval.

The follow-up mode is activated by the second stage of the first switch of the switch module, when the user rotates the rocker arm handle, the sensing module drives the motor to output the second torque for accelerating line retrieval of the fishing reel body; and when the follow-up mode is activated and the user rotates the rocker arm handle, the motor initially outputs the first torque to assist line retrieval. When the sensing module detects an increase in the hand-applied pressure, the host increases the duty ratio of a PWM signal output by the motor, the motor outputs the second torque, and the second torque is proportional to the hand-applied pressure, which further accelerates line retrieval.

The motion-sensing cranking mode 1 (the single-hand mode) is activated by the first stage of the second switch of the switch module, and when the rod-jerking recognition module determines the fish-attracting state according to an identified rod-lifting posture and amplitude of the fishing rod, the motor outputs the first torque for line retrieval, line release, and trolling for attracting fish; and when the mode is activated, the rod-jerking recognition module continuously monitors the rod-lifting posture and amplitude of the fishing rod. When the fish-attracting state is identified, the host controls the motor to output the first torque to perform line retrieval, line release,

and trolling according to a preset fish-attracting program, so as to entice fish to bite by simulating realistic fish-attracting actions.

The motion-sensing cranking mode 2 (the double-hand mode) is activated by the second stage of the second switch of the switch module, and the sensing module drives the motor to output the second torque for accelerating line retrieval of the fishing reel body. When the user grips the fishing rod with both hands, the sensing module sends a signal to the host according to the hand- applied pressure, the host adjusts the PWM signal output by the motor according to the signal, and the motor outputs the second torque to achieve accelerated line retrieval of the fishing reel body. Specifically, the system further includes a photographing module connected to the host, and the photographing module is configured for the user to control the action camera to start or stop recording through a shutter button. The photographing module, by means of a high-resolution CMOS image sensor, supports high-definition photography and video recording. The shutter button is arranged at a position above the grip knob to facilitate operation, and when the user presses the shutter button, the photographing module is rapidly activated.

Specifically, the system further includes a line length reset module, the line length reset module includes a line length reset button, and the button is configured for automatically resetting the line length after the intelligent fishing reel control system is activated and the motor is started. The line length reset module contains a high-precision line length sensor, and based on photoelectric or magnetoelectric principles, the sensor accurately measures a length of the fishing line being released or retrieved. When the line length reset button arranged on the host is pressed, the motor automatically adjusts the length of the fishing line to a preset initial value according to feedback from the line length sensor, to ensure accuracy of line length display.

Specifically, the switch module further includes a power button, and the power button is connected to the host and configured for activating or deactivating the intelligent fishing reel control system. The power button is designed to be waterproof and dustproof and has favorable tactile feedback functions, and the button is pressed and held for three seconds to activate or deactivate the intelligent fishing reel control system.

With reference to FIG. 2, an intelligent fishing reel control method includes the following steps:

S1, press and hold the power button for a preset duration to power on the fishing reel body for use.

Specifically, before use, the user needs to install the battery and the fishing reel body onto the fishing rod and insert an interface of the battery to a power port of the fishing reel, the design that prevents incorrect insertion and facilitates plugging ensures stable connection and convenient

operation, and the power button is short-pressed to check a level of the battery. When the host initiates a battery level detection program, the battery level is intuitively displayed via a display screen or an indicator light, which helps the user to understand remaining battery power of the intelligent fishing reel control system.

S2, press the line length reset button to automatically reset the line length after the motor is started.

Specifically, after the line length reset button is pressed, the host controls the motor to rotate slowly, and the line length sensor monitors length changes of the fishing line in real time. When the length of the fishing line reaches the preset initial value, the motor halts operation to complete the line length reset, which ensures accurate recording of the length of the fishing line being released or retrieved later.

S3, operate the first switch or the second switch to enter a fishing mode.

In the S3, when the user needs to start the motor for assistance in the manual mode, rotational speeds of the motor are adjusted based on the hand-applied pressure detected by the sensing module when the motor outputs the first torque to assist line retrieval of the fishing reel body.

when the user rotates the rocker arm handle in the follow-up mode, the motor outputs the first torque to assist line retrieval, and when the sensing module detects the hand-applied pressure, the motor outputs the second torque to further assist line retrieval of the fishing reel body;

When the user holds the fishing rod with one hand in the motion-sensing cranking mode 1, and when the rod-jerking recognition module determines the fish-attracting state according to an identified rod-lifting posture and amplitude of the fishing rod, the motor outputs the first torque for line retrieval, line release, and trolling for attracting fish; and

when the user grips the fishing rod with both hands in the motion-sensing cranking mode 2, the motor outputs the second torque for accelerating line retrieval of the fishing reel body according to the hand-applied pressure detected by the sensing module.

Specifically, the second torque output by the motor is proportional to the hand-applied pressure, and when the motor outputs the first torque, the rotational speed of the motor is also proportional to the hand-applied pressure.

Specifically, in the fishing mode, a gear ratio of the fishing reel is adjusted through a three-gear mechanical switch, and when the user clearly hears a mechanical clicking sound, it is determined that gear switching is completed. The three-gear mechanical switch is characterized by clear markings and a reliable mechanical structure, and the user is allowed to select different gear ratios by toggling the switch. When the gear ratio is switched, an internal gear mechanism of

the mechanical switch operates. In this case, the user clearly hears a mechanical clicking sound and sees the gear ratio updates on the display screen of the host, and it is determined that gear switching is completed. The user conveniently selects an appropriate gear ratio according to different fishing scenarios and fish sizes.

The foregoing descriptions are merely preferred specific embodiments of the present disclosure, and are not intended to limit the protection scope of the present disclosure. Any equivalent replacements or changes made by a person skilled in the art according to the technical solution of the present disclosure and the inventive concepts thereof within the technical scope disclosed in the present disclosure shall fall within the protection scope of the present disclosure.

1. An intelligent fishing reel control system, being configured to control operations of an electric fishing reel, wherein the electric fishing reel comprises a fishing reel body, a fishing rod, and a battery, and the intelligent fishing reel control system comprises a host, a sensing module, a motor, a switch module, and a rod-jerking recognition module, wherein the host is connected to
the sensing module, the motor, the switch module, and the rod-jerking recognition module to manage each module;
the switch module is configured to activate and switch fishing modes, regulate the motor to operate in different manners in different fishing modes, and supply power to the fishing reel body for line retrieval, line release, and trolling;
the sensing module is configured to detect hand-applied pressure and regulate the motor to operate at variable rotational speeds or torques according to the detected pressure; and
the rod-jerking recognition module is configured to identify a rod-lifting posture and amplitude of a fishing rod, and when a fish-attracting state is identified, the module controls the motor to output a first torque for line retrieval, line release, and trolling of the electric fishing reel to attract fish.

2. The intelligent fishing reel control system according to claim 1, wherein the switch module comprises a first switch and a second switch, both the first switch and the second switch are two- stage switches, the first switch is arranged on a grip knob, and the second switch is arranged on the host; and the grip knob is located at a handgrip position of an end portion of a rocker arm handle.

3. The intelligent fishing reel control system according to claim 2, wherein the fishing modes comprise:
a manual mode, being activated by a first stage of the first switch of the switch module, wherein when the user rotates the rocker arm handle, the sensing module drives the motor to output the first torque for accelerating line retrieval of the fishing reel body;
a follow-up mode, being activated by a second stage of the first switch of the switch module, wherein when the user rotates the rocker arm handle, the sensing module drives the motor to output the second torque for accelerating line retrieval of the fishing reel body;
a motion-sensing cranking mode 1, being activated by the first stage of the second switch of the switch module, wherein when the rod-jerking recognition module determines the fish- attracting state according to an identified rod-lifting posture and amplitude of the fishing rod, the motor outputs the first torque for line retrieval, line release, and trolling for attracting fish; and
a motion-sensing cranking mode 2, being activated by the second stage of the second switch of the switch module, wherein the sensing module drives the motor to output the second torque for accelerating line retrieval of the fishing reel body.

4. The intelligent fishing reel control system according to claim 1, wherein the system further comprises a photographing module connected to the host, and the photographing module is configured for the user to control an action camera to start or stop recording through a shutter
4button.

5. The intelligent fishing reel control system according to claim 1, wherein the system further comprises a line length reset module, the line length reset module comprises a line length reset button, and the button is configured for automatically resetting the line length after the intelligent fishing reel control system is activated and the motor is started.

6. The intelligent fishing reel control system according to claim 1, wherein the switch module further comprises a power button, and the power button is connected to the host and configured for activating or deactivating the intelligent fishing reel control system.

7. An intelligent fishing reel control method, being applied to the intelligent fishing reel control system according to claim 1, comprising the following steps:
S1, pressing and holding the power button for a preset duration to power on the fishing reel body for use;
S2, pressing the line length reset button to automatically reset the line length after the motor is started; and
S3, operating the first switch or the second switch to enter a fishing mode.

8. The intelligent fishing reel control method according to claim 7, wherein in the S3, when the user needs to start the motor for assistance in the manual mode, rotational speeds of the motor are adjusted based on the hand-applied pressure detected by the sensing module when the motor outputs the first torque to assist line retrieval of the fishing reel body;
when the user rotates the rocker arm handle in the follow-up mode, the motor outputs the first torque to assist line retrieval, and when the sensing module detects the hand-applied pressure, the motor outputs the second torque to further assist line retrieval of the fishing reel body;
when the user holds the fishing rod with one hand in the motion-sensing cranking mode 1, and when the rod-jerking recognition module determines the fish-attracting state according to an identified rod-lifting posture and amplitude of the fishing rod, the motor outputs the first torque for line retrieval, line release, and trolling for attracting fish;
when the user grips the fishing rod with both hands in the motion-sensing cranking mode 2, the motor outputs the second torque for accelerating line retrieval of the fishing reel body according to the hand-applied pressure detected by the sensing module; and
accordingly, the second torque output by the motor is proportional to the hand-applied pressure, and when the motor outputs the first torque, the rotational speed of the motor is also proportional to the hand-applied pressure.

9. The intelligent fishing reel control method according to claim 7, wherein before use, the user needs to install the battery and the fishing reel body onto the fishing rod and insert an interface
of the battery to a power port of the fishing reel, and the power button is short-pressed to check a level of the battery.

10. The intelligent fishing reel control method according to claim 7, wherein in the fishing mode, a gear ratio of the fishing reel is adjusted through a three-gear mechanical switch, and when the user clearly hears a mechanical clicking sound, it is determined that gear switching is completed.
